(19) United States
(12) Patent Application Publication
(10) Pub. No.: US 2012/0258668 A1
(43) Pub. Date: Oct. 11, 2012

(54) METHOD AND SYSTEM FOR ENVIRONMENTAL VEHICULAR SAFETY

(75) Inventors: Daniel S. Rokusek, Long Grove, IL (US); Kevin M. Cutts, Lake Zurich, IL (US); Hai Ding, Buffalo Grove, IL (US)

(73) Assignee: MOTOROLA MOBILITY, INC., Libertyville, IL (US)

(21) Appl. No.: 13/080,804

(22) Filed: Apr. 6, 2011

(51) Int. Cl. H04B 7/00

(52) U.S. Cl. 455/66.1

(57) ABSTRACT

A method is described for launching a vehicular camera application residing on a docked mobile communication device, such as a smartphone, tablet computer, or mp3 player, for example. A common feature for the many choices of a mobile communication device is that the mobile communication device comprises embedded data processing capability. The launching operation of the vehicular camera application includes detecting a communicative coupling of the mobile communication device with a docking device; and thereafter initiating the vehicular camera application that resides on the mobile communication device. Images are displayed on the mobile communication device that was captured by a vehicular camera or a camera integrated with the mobile communication device or communicatively coupled to the mobile communication device. The associated camera may be controlled by the vehicular camera application

### FIELD OF THE INVENTION

The present invention is related to vehicular safety systems. Specifically, the present invention is related to integrated vehicular sensors that provide enhanced external awareness to drivers, especially cameras and proximity sensors.

### BACKGROUND OF THE INVENTION

Conventional vehicle camera systems are typically stand-alone devices having displays or are after market portable navigation devices that offer this feature. For the vehicle user, this can lead to increased cost and increased dashboard clutter, as well as significant installation impact to the vehicle itself. More importantly, the stand-alone devices are not integrated with a vehicle user's mobile communication device, such as a cellular or mobile phone, mp3 player, or a tablet computer.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an exemplary flowchart;

FIG. 2 is an exemplary flowchart;

FIG. 3 is an exemplary flowchart;

FIG. 4 is an exemplary environmental vehicular communication system;

FIG. 5 is another exemplary environmental vehicular communication system;

FIG. 6 is a block diagram for an exemplary mobile communication device;

FIG. 7 is a block diagram for an exemplary docking device that includes a security chipset;

FIG. 8 is a block diagram for an exemplary computer server;

FIG. 9 is an exemplary smartphone; and

FIGS. 10A-10D are working examples of screenshots taken from a smartphone.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. The method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Disclosed herein is a method for launching a vehicular camera application residing on a docked mobile communication device, such as a smartphone, tablet computer, or mp3 player, for example. A common feature for the many choices of a mobile communication device is that the mobile communication device comprises embedded data processing capability. The launching operation of the vehicular camera application includes detecting a communicative coupling of the mobile communication device with a docking device; and thereafter initiating the vehicular camera application that resides on the mobile communication device. Images are displayed on the mobile communication device that was captured by a vehicular camera or a camera integrated with the mobile communication device or communicatively coupled to the mobile communication device. The associated camera may be controlled by the vehicular camera application and may comprise one or more image sensors such as a charge-coupled device (CCD) or a complementary metal oxide semiconductor (CMOS). In addition, other sensors may be communicatively coupled to the mobile communication device and may provide input for launching the vehicle application as well. For example, lasers, radars, or more specifically LIDAR detectors and ultrasonic sensors may be employed in combination with a vehicle camera or instead of a vehicle camera. These exemplary sensors provide valuable data about the external environmental perimeter surrounding a vehicle. These sensors may be located on the front, side, bottom, and rear of a vehicle. The sensors may be communicatively coupled via a wireless system, such as Bluetooth or may be hardwired to the mobile communication device.

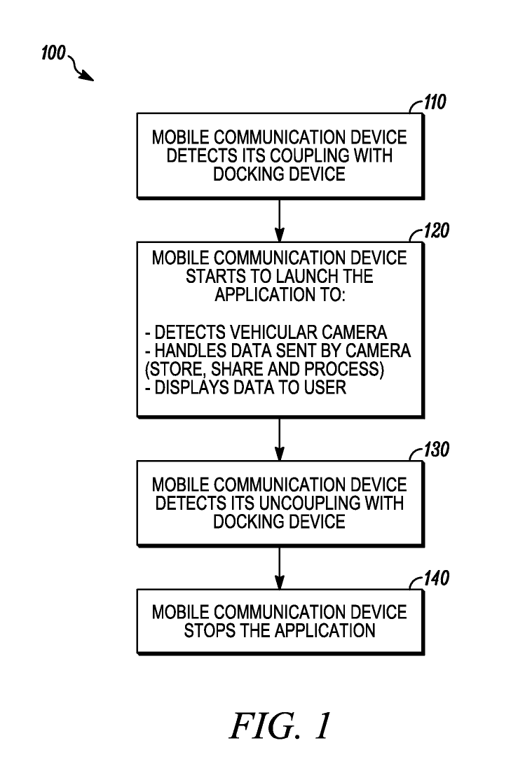

Referring to FIG. 1, an exemplary flowchart 100 is shown. Operation 110 includes the mobile communication device detecting that it is coupled to a docking device. The coupling and detecting of coupling with a docking device are fully described in U.S. patent application Ser. No. 13/047,265, filed Mar. 14, 2011, and is incorporated herein by reference. Docking may be wireless or a tethered operation. Upon detection of coupling operation 110, the mobile communication device starts or initializes a resident or local application for environmental vehicle safety in operation 120. The local environmental vehicle safety application on the mobile communication device may detect a communicatively coupled vehicular camera or enable operation of an internal or integrated camera within the mobile communication device. The associated camera can store, share, and process both still and moving images, such as video that have been captured by the camera. The still images can be consecutive and may comprise several still images at once, and may be referred to as burst images. All images captured by the associated camera may be displayed on the mobile communication device.

Operation 130 in flowchart 100 detects that the mobile communication device is communicatively uncoupled from its docking device. Upon detection of an uncoupling signal, operation 140 sends a stop signal from the mobile communication device to its local environmental vehicle safety application that resides on the mobile communication device.

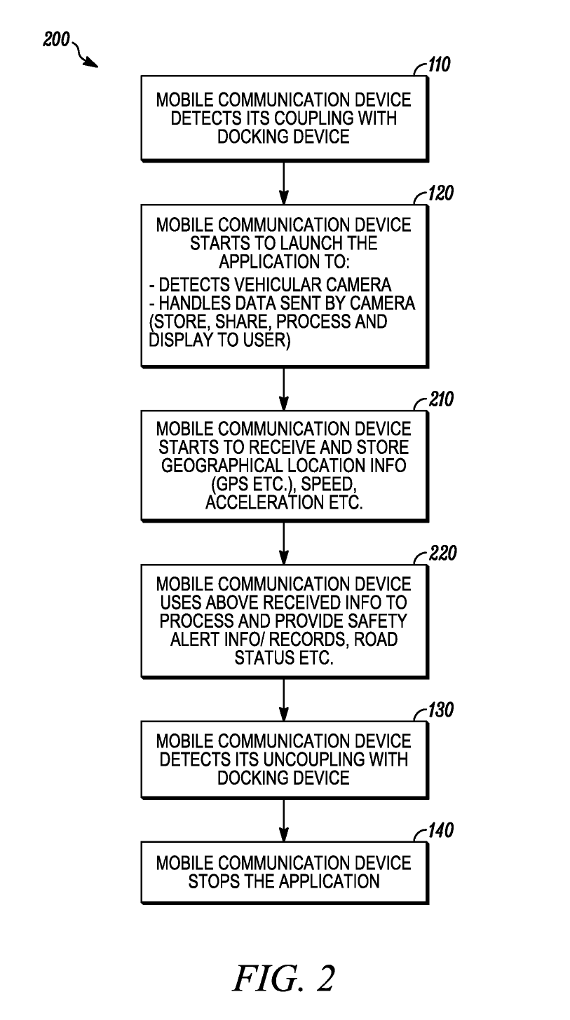

Referring to FIG. 2, an exemplary flowchart 200 is shown. Several operations or steps from flowchart 100 in FIG. 1 are included and thus retain the same nomenclature for greater clarity. In addition to these operations are operations 210 and 220. Operation 210 provides instruction to the mobile communication device to receive and store geographical location information, for example global positioning data, and vehicular speed, gyroscope data, and acceleration data from the mobile communication device itself. Operation 220 enables the mobile communication device to use the aforementioned received data or information within a processor or controller of the mobile communication device to provide safety alert information, vehicular and pedestrian traffic conditions, road status, such as construction details, and road conditions such as wet or dry pavement, road configuration, for example curved road or straight road.

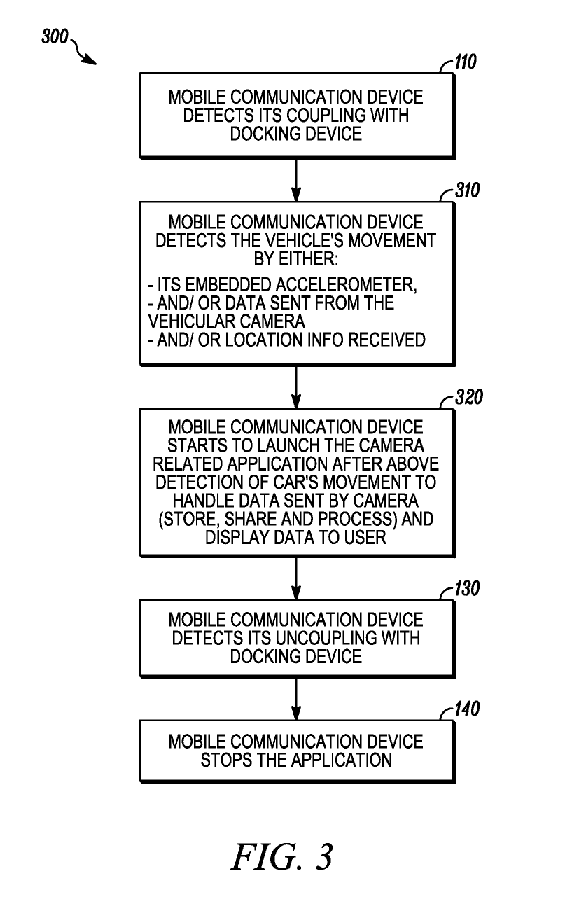

Referring to FIG. 3, an exemplary flowchart 300 is shown. In addition to previously described operations 110-140, flowchart 300 includes operations 310 and 320. Specifically, operation 310 provides instruction for the mobile communication device to detect the associated vehicle's movement that it is coupled to via the vehicle's docking device. The vehicle's movement may be detected by an embedded accelerometer in the mobile communication, for example, or by analyzed and processed data captured from an associated vehicle camera or a geographical location system, such as GPS.

Upon detection of the vehicle's movement via operation 310, operation 320 initializes or launches the environmental vehicle safety application. The application enables data related to a vehicle camera or other sensor to be stored, shared, and processed for subsequent display upon the mobile communication device or upon a display communicatively coupled to mobile communication device, such as a pop-up display or hologram, for example. One or more driver safety-related applications may include controlling on/off display operation and other display functions for themobile communication device upon the detection of a vehicle's motion via either the accelerometer in the mobile communication device, or any triggering info sent by the coupled vehicular camera.

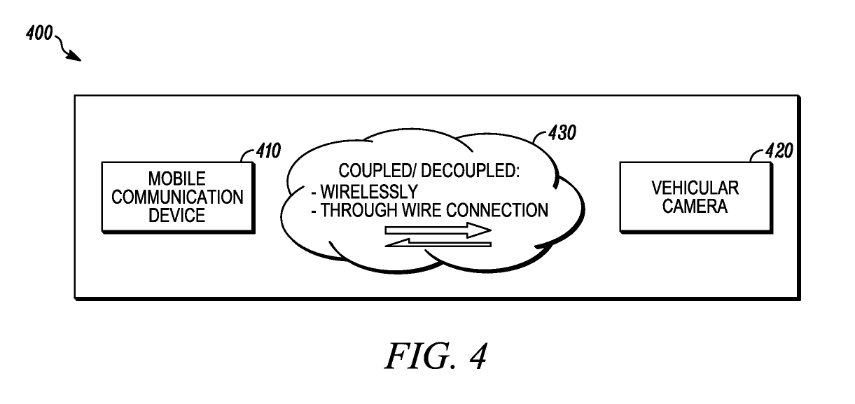

Referring to FIG. 4, an exemplary environmental vehicular communication system 400 is shown. Environmental vehicular communication system 400 includes at least a mobile communication device 410 that may be coupled or decoupled to/from a vehicular camera 420 via a wireless or wired network 430. These components are not an exhaustive list, but represent a simplified illustration of one environmental vehicular communication system.

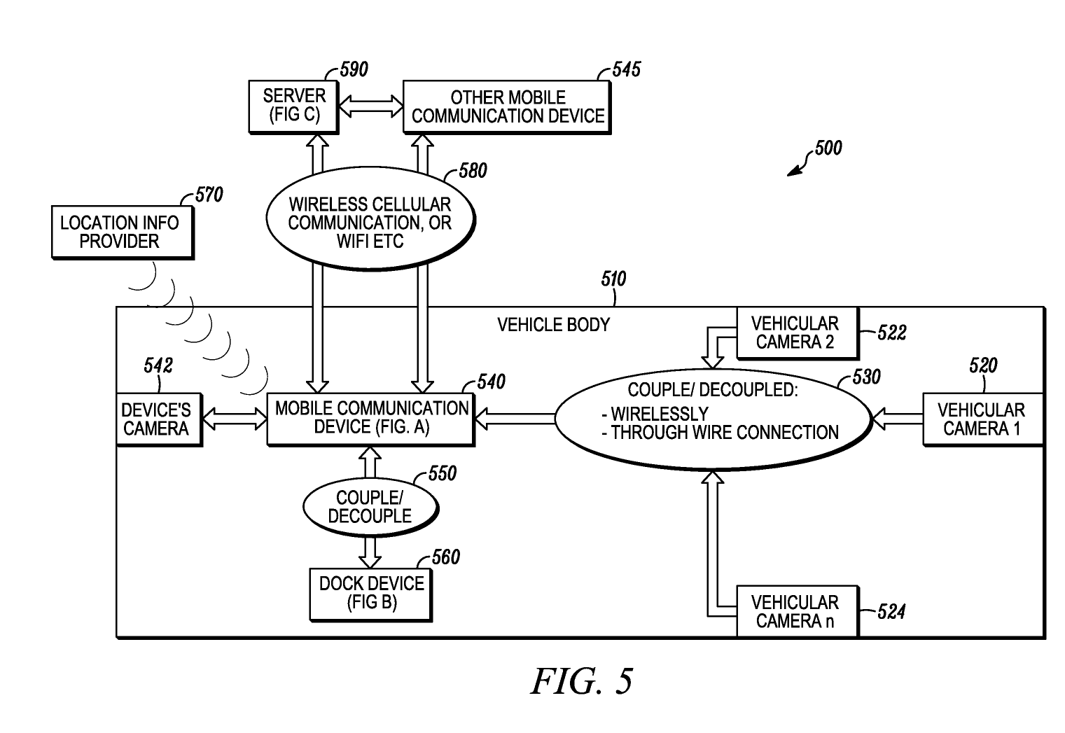

Another environmental vehicular communication system is shown, for example, in FIG. 5. Environmental vehicular communication system 500 includes a vehicle's body 510 in which components and signals may either reside internally or externally and may traverse vehicle body 510. For example, inside or external to vehicle body 510 lies several vehicle cameras, vehicle camera 520, vehicle camera 522, and vehicle camera 524. The number of vehicle cameras may be more or less than pictured. Nevertheless, they are coupled and decoupled via a network 530 to at least one mobile communication device 540. As stated earlier, network 530 may be wired or wireless. Mobile communication device 540 may be coupled or decoupled via network 550 to docking device 560. In addition, mobile communication device 540 may be communicatively coupled to a device camera 542, wherein the device camera may be internal to the mobile communication device 540, for example.

Another network, network 580, which is communicatively coupled to the mobile communication device 540 may be either a cellular network or a WiFi network for communication with another mobile communication device 545 or a server network 590 that are external to vehicle body 510. The second mobile communication device 545 also may be communicatively coupled to the server network 590. The environmental vehicle safety system 500 may receive geographical location information or data from a global positioning system, such as GPS or Global Navigation Satellite System (GLONASS), or Beidou Satellite Navigation System.

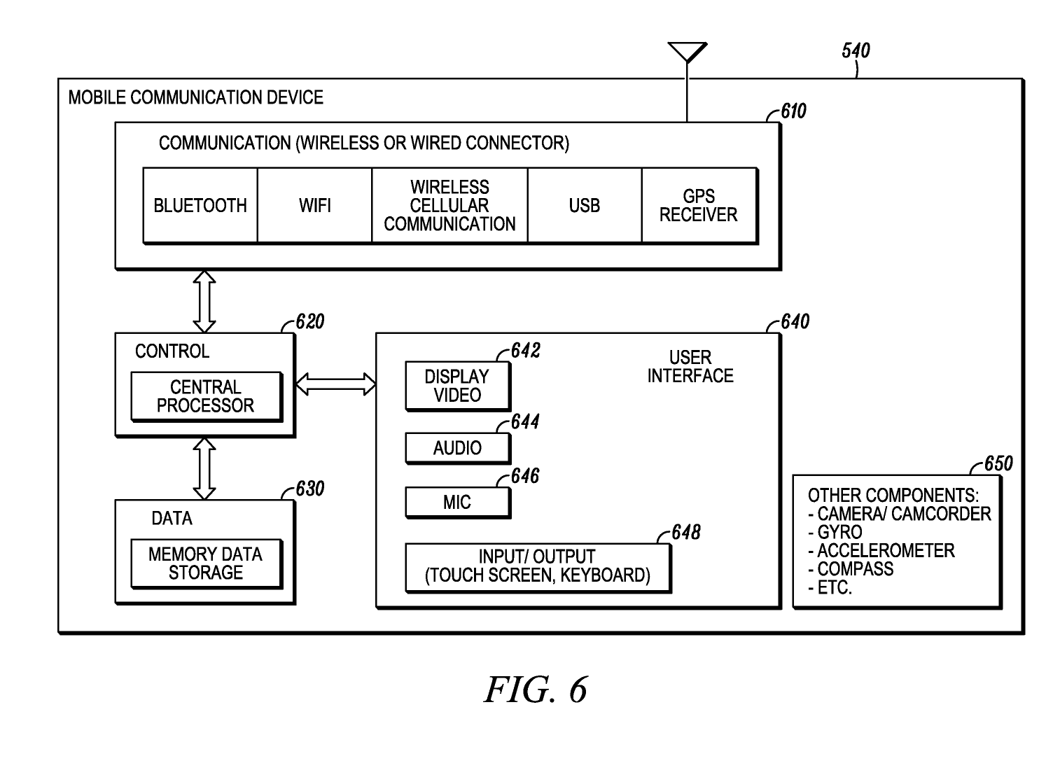

Mobile communication device 540 or 545 is further illustrated by example in FIG. 6, and may include a communication module 610 communicatively coupled to a control module 620. Control module 620 is shown as communicatively coupled to a data module 630 and a user interface module 640. The communication module 610 may have a wireless or a wired connector, as well. Accordingly, communication module can be capable of receiving and sending signals compatible with Bluetooth, Wi-fi, wireless cellular communication, USB, or may include a GPS receiver.

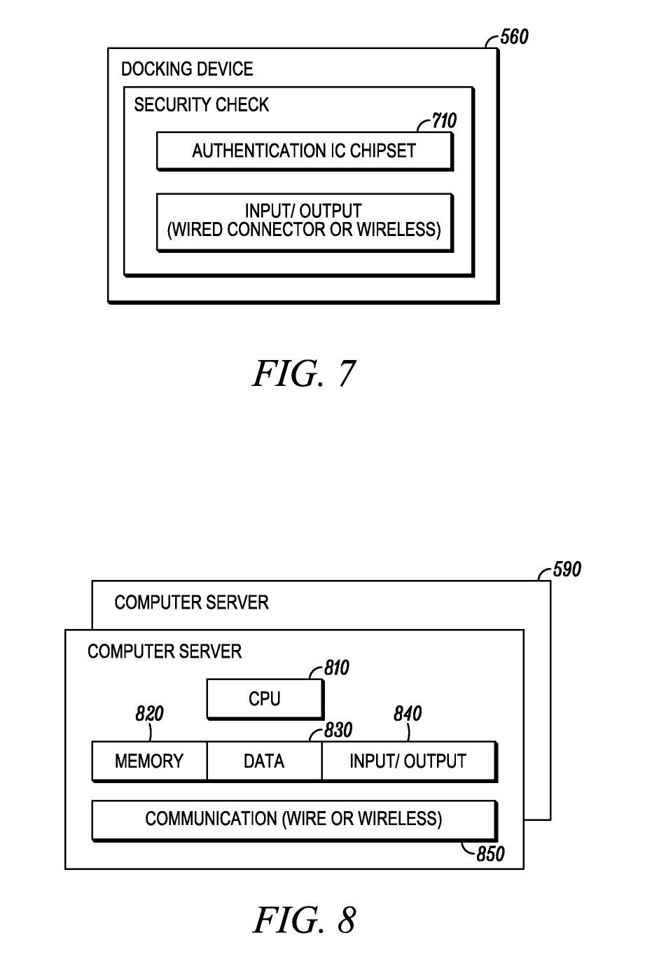

The control module 620 includes a central processor capable of running operations programs for the mobile communication device 540 or 545. Data module 630 includes a memory data storage unit capable of retaining and erasing or flushing geographical location information. The memory data storage unit can be or include any data retention apparatus, including secure disk (SD)card, micro-SD, thumb-drive, external hard drives, personal electronic devices, and tape drives or microfiche, for example. A stored digital map in the memory data storage unit can be used as a comparison to a real time geographical location as captured by the vehicular camera or mobile communication device. The stored digital map may be editable so that the content can be updated based on the real time information captured by the vehicular camera or mobile communication device. The user interface module 640 shown in FIG. 6 may include a display 642 for still and moving images; an audio outlet 644, for example one or more speakers and an audio jack; a microphone 646 for voice input; and a user manual input 648 that can be a touchscreen or a keyboard or both. Accessory coupled components 650 may include a camera, a camcorder, a gyroscope, an accelerometer, and a compass; each of which may provide data to control 620 and data 630. The electronic accessories can be powered by primary power source such as integrated and electronically coupled batteries or a secondary power source such as a back-up lamp of the vehicle. A docking device is further illustrated in FIG. 7. Docking device 560 may include status detection for determining whether the docking device has been actually coupled or decoupled from mobile communication device 540. Docking device 560 may include authentication handling via an authentication chipset 710. Any likely communication from docking device 560 may also include the authentication result from authentication chipset 710 shown in FIG. 7.

FIG. 8 shows an exemplary server 590 that includes several of the same components shown in FIG. 6 for the mobile communication device 540. As such, server 590 can handle like data traffic, associated with geographical locations, in a similar manner as mobile communication device 540. Specifically, server 590 includes a central processing unit, CPU 810 communicatively coupled to a memory module 820, a data module 830, an input/output module 840; and a communication module 850 that may be further include a wired or wireless connector. Several programs may reside on server 590, including detecting coupling and decoupling with docking device 560; updating status detection associated with coupling and decoupling with docking device 560; receiving geographical location information or data; recording geographical location information or data; sharing recorded geographical location information amongst several mobile communication devices, handling database data and user interface manipulation; handling wired and wireless communication.

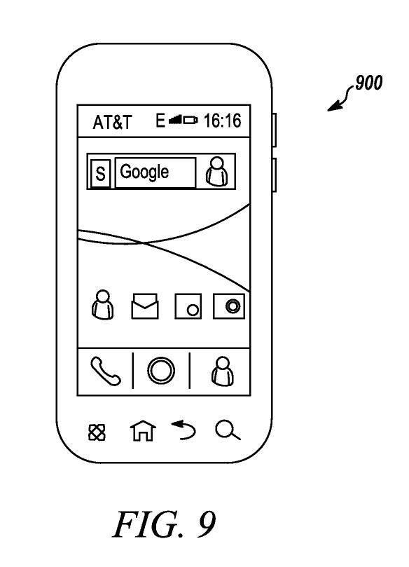

FIG. 9 shows an exemplary smartphone 900 as contemplated mobile communication device that will display relevant safety alerts and traffic conditions upon its display screen and be operational via a user interface.

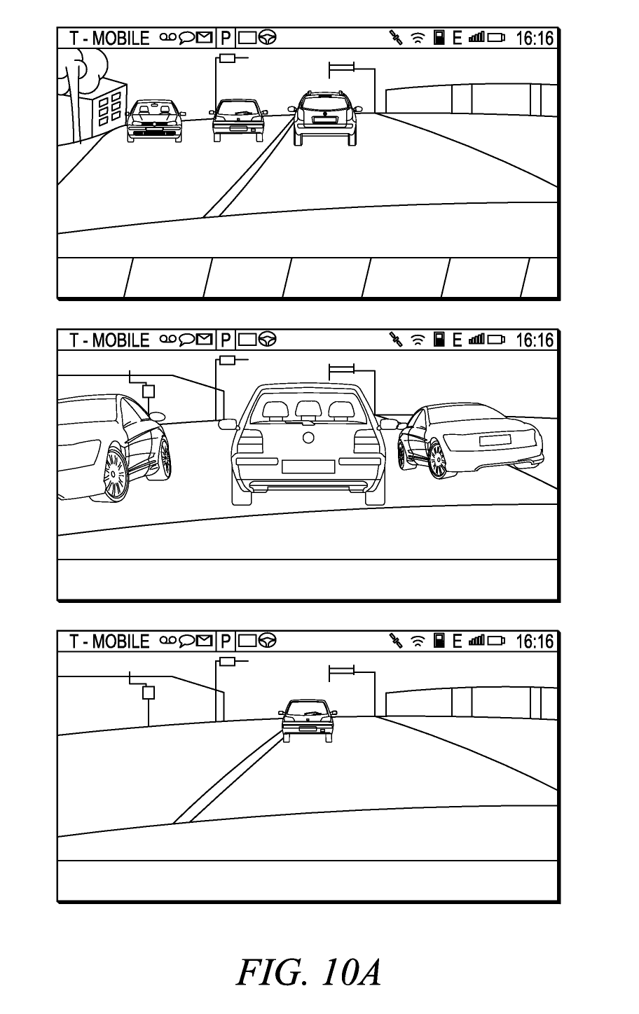

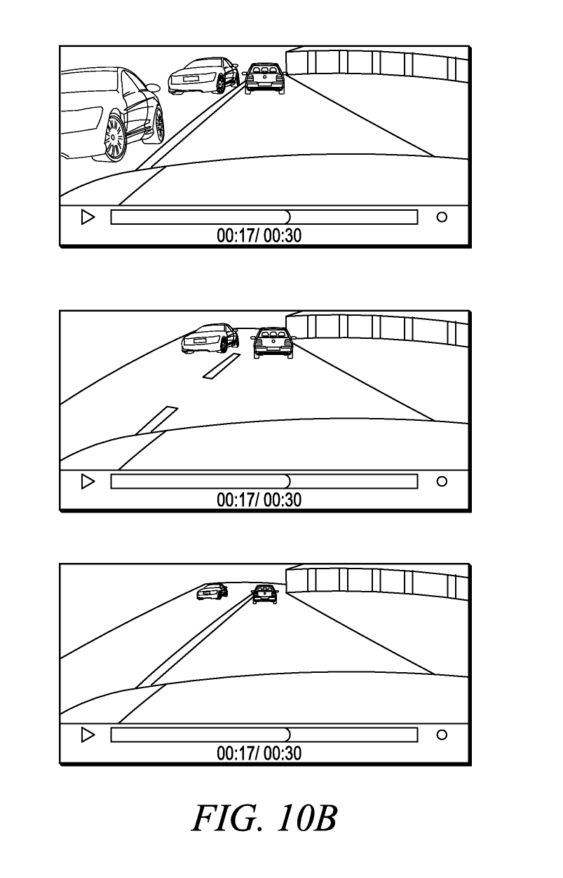

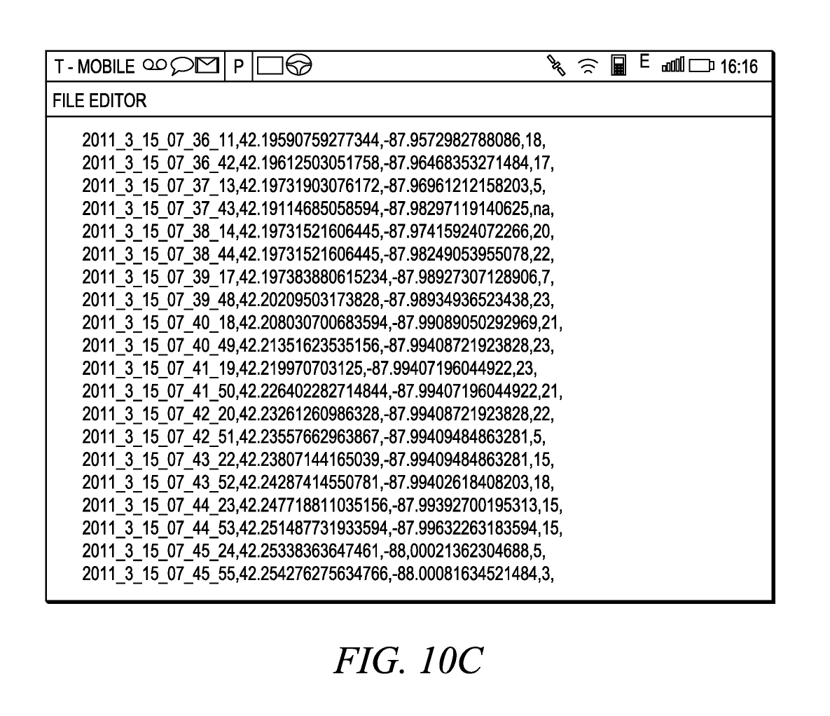

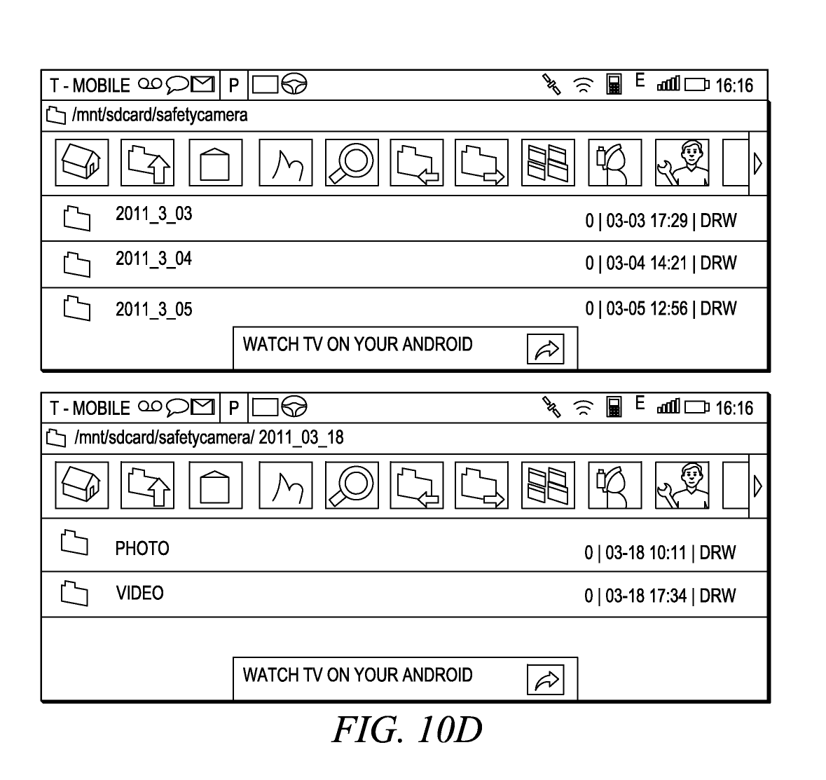

Several screenshots from smartphone 900 are illustrated in FIGS. 10A-10D. In FIG. 10 A, several still images or pictures that have been consecutively captured by an internal camera in smartphone 900 are controlled by an environmental vehicle safety application residing on smartphone 900. That is the application may control the interval of image capturing, for example, either 10 seconds or 2 seconds may be used as an image capturing interval for the internal camera of smartphone 900 or a vehicular camera external to smartphone 900. That is the vehicular camera may capture consecutive still images within a predetermined elapsed period of time.

Depicted in FIG. 10B are several snapshots of individual video clips that were consecutively taken by an internal camera of smartphone 900. As such, the vehicular camera may capture real-time video images within a predetermined elapsed period of time. The vehicular camera may also record sudden vehicle movement, for example, a rapid evasive driving maneuver to avoid an object or person in the vehicle's path. A local environmental vehicle safety application, residing on smartphone 900, may control the duration of the image capturing resulting in a video clip of 30 seconds, for example. FIG. 10 C illustrates associated image metadata files created by environmental vehicle safety application residing on smartphone 900 that may include a timestamp, a latitude position, a longitude position, and vehicular driving speed. Finally, FIG. 10D illustrates that the environmental vehicle safety application residing on smartphone 900 may store the data associated with imaging, including image files and metadata. In addition the environmental vehicle safety application residing on smartphone 900 may transmit, share, and archive said data as well.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions or code (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a non-transitory machine readable storage device or medium having computer readable code stored thereon for programming a computer (e.g., comprising a processor) to perform a method as described and claimed herein. Examples of such non-transitory machine readable storage devices or mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for launching a vehicular camera application residing on a docked mobile communication device, comprising the steps of:
detecting communicative coupling of the mobile communication device with a docking device; wherein the mobile communication device comprises embedded data processing capability;
initiating the vehicular camera application residing on the mobile communication device upon detection of the mobile communication device's communicative coupling with the docked device; and
displaying images on the mobile communication device that were captured by a vehicular camera or a camera communicatively coupled to the mobile communication device and controlled by the vehicular camera application.

2. The method according to claim 1, further comprising the step of launching driver safety-related applications that coincide with the recorded images from the vehicular camera.

3. The method according to claim 2, wherein the driver safety-related applications comprise controlling on/off display operation and other display functions for the mobile communication device upon the detection of a vehicle's motion via either the accelerometer in the mobile communication device, or any triggering info sent by the coupled vehicular camera.

4. The method according to claim 2, wherein the driver safety-related applications comprise analyzing road conditions for a vehicle coupled to the vehicular camera.

5. The method according to claim 4, further comprising the step of providing a notification on the mobile communication device of the analyzed road conditions.

6. The method according to claim 1, wherein the mobile communication device is coupled wirelessly to the vehicular camera.

7. The method according to claim 1, wherein the mobile communication device is wired to the vehicular camera.

8. The method according to claim 2, wherein the vehicular camera captures consecutive still images within a predetermined elapsed period of time.

9. The method according to claim 2, wherein the vehicular camera captures real-time video images within a predetermined elapsed period of time.

10. The method according to claim 1, wherein the images captured by the vehicular camera are archived to a memory storage device.

11. The method according to claim 1, wherein the memory storage device consists of the group secure disk (SD)card, micro-SD, thumb-drive, external hard drives, personal electronic device.

12. The method according to claim 1, wherein the images captured by the vehicular camera include metadata comprising a time stamp, a geographical location, and driving speed. Such metadata can also be created and provided by the mobile communication device during camera data processing with receipt of the location info from satellite or network station.

13. The method according to claim 1, wherein the vehicular camera is electrically connected to a back-up lamp of the vehicle to provide a power source for the vehicular camera.

14. The method according to claim 1, wherein the vehicular camera is located in a plurality of positions on the vehicle, the plurality of spots consisting of rear, front, side, internal and underneath positions of the vehicle.

15. The method according to claim 1, wherein the vehicular camera includes a charge-coupled (CCD) sensor or a CMOS sensor.

16. The method according to claim 1, wherein associated vehicle data is shared via a communications network.

17. A non-transitory machine readable storage device having stored thereon a computer program that includes a plurality of code sections comprising:
code for detecting communicative coupling of the mobile communication device with a docking device; wherein the mobile communication device comprises embedded data processing capability;
code for initiating the vehicular camera application residing on the mobile communication device upon detection of the mobile communication device's communicative coupling with the docked device; and
code for displaying images on the mobile communication device that were captured by a vehicular camera or a camera communicatively coupled to the mobile communication device and controlled by the vehicular camera application.

18. The non-transitory machine readable storage device according to claim 17, further comprising code for launching driver safety-related applications that coincide with the recorded images from the vehicular camera.

19. The non-transitory machine readable storage device according to claim 17, further comprising code for controlling on/off display operation and other display functions for the mobile communication device upon the detection of a vehicle's motion via either the accelerometer in the mobile communication device, or any triggering info sent by the coupled vehicular camera.

20. The non-transitory machine readable storage device according to claim 17, further comprising code for analyzing road conditions for a vehicle coupled to the vehicular camera.
